(19) United States
(12) Patent Application Publication
(10) Pub. No.: US 2008/0256037 A1
(43) Pub. Date: Oct. 16, 2008

(54) METHOD AND SYSTEM FOR GENERATING AN ORDERED LIST

(76) Inventors: Sihem Amer Yahia, New York, NY (US); Lin Guo, Mountainview, CA (US); Raghu Ramakrishnan, Los Altos, CA (US); Jayavel Shanmugasundaram, Santa Clara, CA (US); Utkarsh Srivastava, Santa Clara, CA (US); Andrew Tomkins, San Jose, CA (US); Erik Vee, San Jose, CA (US)

Correspondence Address: BRINKS HOFER GILSON & LIONE / YAHOO! OVERTURE, P.O. BOX 10395, CHICAGO, IL, 60610, US

(21) Appl. No.: 11/734,300

(22) Filed: Apr. 12, 2007

(51) Int. Cl. G06F 17/30

(52) U.S. Cl. 707/3

(57) ABSTRACT

A system for generating an ordered list. The system may include a query engine and an advertisement engine. The query engine receives a query from the user and determines parameters to match with the advertisement. The advertisement engine receives the parameters and generates a list of items based on the parameters. The system may function in a precompute mode to calculate intervals for each available item to minimize the variable processing costs for each item. Further, the number of intervals a crossed item may be selected in a manner to satisfy a given space constraint. By characterizing each item by a minimum price within each interval, the system can quickly query the interval matching the desired quantity for each item and determined if the minimum price for that interval is less than the top-k prices already included in the list.

### BACKGROUND

1. Field of the Invention

The present invention generally relates to a system and method for generating an ordered list.

2. Description of Related Art

Online shopping has become an increasingly popular activity and millions of customers use the Web today to purchase items. Customers are usually presented with a fielded search interface using which they can specify selection criteria such as the check-in/check-out dates for a hotel room, the color/model of printer cartridges and the make/model of cell-phones. The items that satisfy the selection criteria are then returned in the order of their price. Travel aggregators and online stores often offer price discounts based on purchasing a certain quantity of items. Such discounts are usually in the form of promotional rules such as “Stay 3 nights, get a 15% discount on double-bed rooms”, “Buy 2 Canon printer cartridges, get the third one free” and “Buy 2 Motorola Razr cell-phones, get $50 off”. Thus, depending on the user query and the properties of an item, only some of these promotional rules may apply. Due to the potentially large number of items and promotional rules, the ability to compute the discounted price for each item at query time and return items ranked by their discounted price, is a key factor in the efficiency of online shopping.

The simplest and most common solution to the above problem is to select the items that satisfy the user query, apply the applicable promotional rules to each selected item, and return the top few items with the lowest price. While this approach performs reasonably well for a small number of items and promotional rules, it suffers from obvious scalability problems when the number of items and promotional rules increases. This problem is particularly bad for travel aggregators such as hotels.com and travelocity.com, which have to issue an expensive web service call to the site responsible for each item to check for its discounted price.

In view of the above, it is apparent that there exists a need for an improved system and method for generating a list of advertisements.

### SUMMARY

In satisfying the above need, as well as overcoming the drawbacks and other limitations of the related art, a system and method for generating a list of advertisements is provided.

The system includes a query engine and an advertisement engine. The query engine receives a query from the user and determines parameters to match with the advertisement. The advertisement engine receives the parameters and generates a list of items based on the parameters. The system may function in a precompute mode to calculate intervals for each available item to minimize the variable processing costs for each item. For example, the price per unit may vary based on desired quantity. Further, the price per unit may be a function of multiple pricing rules in affect for each item. Accordingly, the pricing rules over a quantity interval may be generalized by the minimum price per unit within the interval. Further, the number of intervals a crossed item may be selected in a manner to satisfy a given space constraint. By characterizing each item by a minimum price within each interval, the system can quickly query the interval matching the desired quantity for each item and determined if the minimum price for that interval is less than the top-k prices already included in the list. If the minimum price is not less than the top-k items on the list, the system can quickly index to the next item. Alternatively, if the minimum prices is less than the top-k price on the list, the item may be added to the list or the actual price may be calculated for further comparison.

Accordingly, when identifying intervals, the system may start analyzing each item using a single interval and continuously increase the number of intervals while determining the split points that yield the maximum processing benefit. As such, the minimum price for each interval is stored along with the processing benefit achieved by adding each interval to an item. Thereafter, the intervals may be combined by optionally smoothing the benefit data and selecting the number of intervals for each item that yields the overall largest processing benefit that can be achieved within the given space constraint.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for generating a list of advertisements;

FIG. 2 is a graph illustrating a pricing rule;

FIG. 3 is a graph illustrating another pricing rule;

FIG. 4 is a graph illustrating the combination of the pricing rules in FIG. 2 and FIG. 3;

FIG. 5 is a flow chart illustrating a method for creating a list of items;

FIG. 6 is a flow chart of a method for determining intervals;

FIG. 7 is a flow chart of a method for combining intervals across items;

FIG. 8 is a flow chart illustrating a method of generating a list of advertisements based on a query;

FIG. 9 is a schematic view of the proportional integral algorithm; and

FIG. 10 is a graph illustrating culprits.

### DETAILED DESCRIPTION

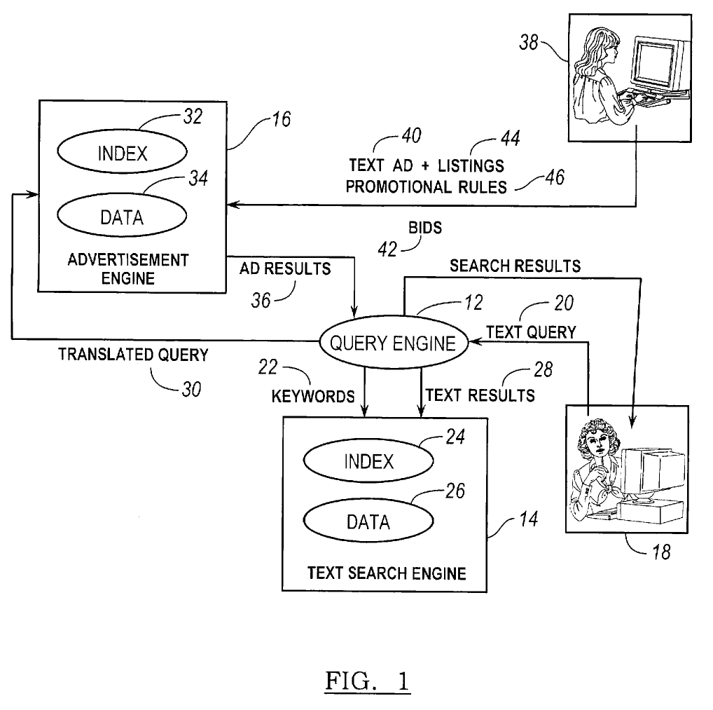

Referring now to FIG. 1, a system embodying the principles of the present invention is illustrated therein and designated at 10. The system 10 includes a query engine 12, a text search engine 14, and an advertisement engine 16. The query engine 12 is in communication with a user system 18 over a network connection, for example over an Internet connection. The query engine 12 is configured to receive a text query 20 to initiate a web page search. The text query 20 may be a simple text string including one or multiple keywords that identify the subject matter for which the user wishes to search.

Referring again to FIG. 1, the query engine 12 provides the text query 20 to the text search engine 14, as denoted by line 22. The text search engine 14 includes an index module 24 and the data module 26. The text search engine 14 compares the keywords 22 to information in the index module 24 to determine the correlation of each index entry relative to the keywords 22 provided from the query engine 12. The text search engine 14 then generates text search results by ordering the index entries into a list from the highest correlating entries to the lowest correlating entries. The text search engine 14 may then access data entries from the data module 26 that correspond to each index entry in the list. Accordingly, the text search engine 14 may generate text search results 28 by merging the corresponding data entries with a list of index entries. The text search results 28 are then provided to the query engine 12 to be formatted and displayed to the user.

The query engine 12 is also in communication with the advertisement engine 16 allowing the query engine 12 to tightly integrate advertisements with the user query and search results. To more effectively select appropriate advertisements that match the user's interest and query intent, the query engine 12 may be configured to further analyze the text query 20 and generate a more sophisticated translated query 30. The query intent may be better categorized by defining a number of domains that model typical search scenarios. Typical scenarios may include looking for a hotel room, searching for a plane flight, shopping for a product, or similar scenarios.

One example may include the text query “New York hotel August 23”. For this example, the query engine 12 may analyze the text query 20 to determine if any of the keywords in the text query 20 match one or more words that are associated with a particular domain. The words that are associated with a particular domain may be referred to as trigger words. Various algorithms may be used to identify the best domain match for a particular set of keywords. For example, certain trigger words may be weighted higher than other trigger words. In addition, if multiple trigger words for a particular domain are included in a text query additional weighting may be given to that domain.

The translated query 30 is provided to the advertisement engine 16. The advertisement engine 16 includes an index module 32 and a data module 34. The advertisement engine 16 performs an ad matching algorithm to identify advertisements that match the user's interest and the query intent. The advertisement engine 16 compares the translated query 30 to information in the index module 32 to determine if each index entry matches to the translated query 30 provided from the query engine 12. The index entries may be ordered in a list from lowest price to highest price for a predefined number of items. The list may be referred to as a top-k list where k represents the predefined number of items. The advertiser system 38 allows advertisers to edit ad text 40, bids 42, listings 44, and rules 46. The ad text 40 may include fields that incorporate, domain, general predicate, domain specific predicate, bid, listing or promotional rule information into the ad data.

The advertisement engine 16 may then generate advertisement search results 36 by ordering the index entries into a list from the lowest priced entries to the highest priced entries. The advertisement engine 16 may then access data entries from the data module 34 that correspond to each index entry in the list from the index module 32. Accordingly, the advertisement engine 16 may generate advertisement results 36 by merging the corresponding data entries with a list of index entries. The advertisement results 36 are then provided to the query engine 12. The advertisement results 36 may be incorporated with the text search results 28 and provided to the user system 18 for display to the user.

A naive way of indexing promotional rules is to precompute and explicitly store the discounted price for each item-quantity pair. Thus, when a user issues a query for a given quantity, the discounted price for the items that satisfy the user query can be looked up directly, and the top few results can be returned to the user. However, this simple approach can lead to a significant space requirement because the number of items and the number of possible quantities can be quite large; this extensive space requirement is particularly undesirable in large online sites, which, store large parts of the data in main-memory to achieve the desired throughput and response time. A related disadvantage of this approach is that the discounted price has to be precomputed for all quantities and items, even though many quantities are rarely queried and many items rarely make it to the top few results.

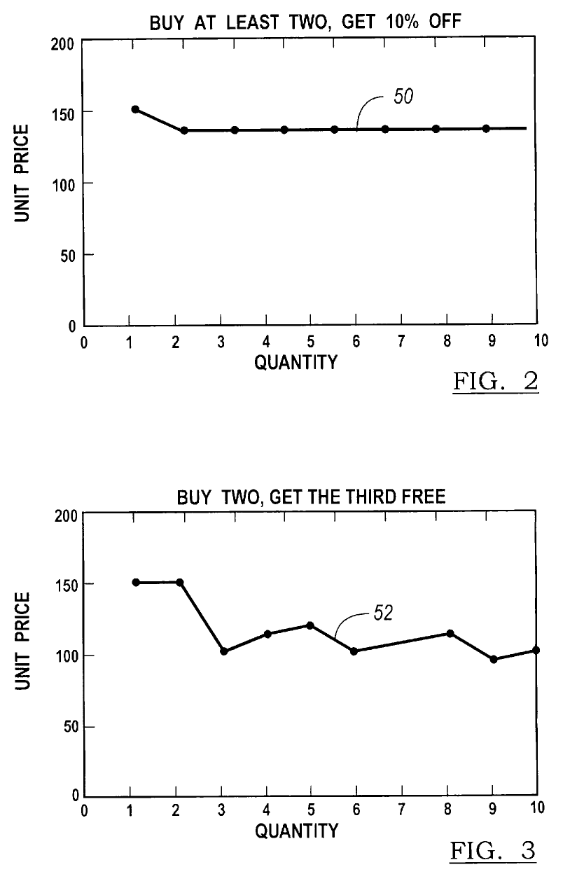

To address the limitations of the naive approach, a promotional rule associated with an item i is modeled as a function that takes as input a quantity q, and returns the discounted unit price for that quantity. For instance, “Buy at least 2 Motorola cell-phones, get 10% off the unit price” can be modeled as a function f associated with a Motorola cell-phone, where f(q)=p, q=1 and f(q)=0.90×p, q≧2, where p is the regular (non-discounted) price for a cell-phone. This function is illustrated in FIG. 2. Then, given a space budget, each function is split into one or more quantity intervals (shown as vertical bars in the figure) such that the total number of intervals across all items does not exceed the space budget. For each interval, the minimum value of the function is stored for that interval. For instance, we can naturally split the above function f into two intervals I₁ and I₂:I₁ captures quantity range 1≦q≦1 and the minimum value of f in that range is p, I₂ captures the quantity range q>2 and the minimum value of f in that range is 0.90×p. As described, the intervals capture an entire range of functions compactly, which can lead to significant space savings.

However, representing functions as intervals introduces new challenges for query processing: since only store the minimum price for a given item and interval (for space-savings) is stored, some post query processing needs to be done to determine the actual discounted price for each item, and post query processing can be expensive if it has to be done for many intervals. To address this issue, a threshold algorithm can be adapted to prune away a large number of items and intervals that cannot possibly make it to the top few results, thereby greatly reducing the cost of post-processing. A straightforward adaptation of the threshold algorithm would not suffice given that the set of functions that qualify to compute the discounted price of a query answer is only known at query time and varies from item to item. For example, given a query looking for 2 printer cartridges, the rules “Buy 2 Canon printer cartridges of any color, get the third one free” and “Buy at least 2 red printer cartridges of any type, get $5 off the total price” would both apply to a red Canon printer cartridges while only the former one would apply to non-red printer cartridges.

An algorithm is also provided for determining appropriate function intervals for a given set of items and promotional rules. The algorithm takes in a space budget and uses the query workload to identify the items and functions that most need to be split into intervals, and produces a set of intervals that are provably close to optimal. An interesting aspect of the algorithm is that it makes very few assumptions on the nature of functions, and it thus can be applied to a very broad class of promotional rules. Experiments have shown that the proposed approach offers orders of magnitude improvement in performance over other approaches. In particular, it is shown that by increasing the space budget to only 1.5 the size of the database of items, the algorithm is 5 orders of magnitude faster than other approaches.

Items may be stored in the advertisement engine as tuples in a relation, with a distinguished attribute storing the price of the item (without applying any discounts). The notation i.price is used to refer to the pre-discount price of item i. Table 1 shows some items stored in a relation that stores cell-phones.

TABLE 1

| ItemId | Title | Make | Model | Unit-weight | Price |
|---|---|---|---|---|---|
| 1 | Panasonic VS2 | Panasonic | DC643 | 0.35 lbs | $250 |
| 2 | Panasonic VS3 | Panasonic | GDC65 | 0.22 lbs | $90 |
| 3 | Siemens D345 | Siemens | D345 | 0.38 lb | $80 |
| 4 | Motorola Razr D28 | Motorola | Razr | 0.20 lbs | $150 |
| 5 | Motorola Sleek | Motorola | Sleek | 0.42 lbs | $120 |
| | DC43 | | | | |

TABLE 2
Promotional Rules for Cell Phones

P₁: Buy 2 Motorola cell-phones of the same type, get the third one free
P₂: Buy at least 2 Motorola Razr cell-phones, get 10% off the unit price
P₃: Buy at least 2 Siemens cell-phones, get $50 off the total price
P₄: Buy 3 Panasonic VS2 phones, get 60% off

Similarly, there can be many other relations corresponding to different item categories such as laptops, printer cartridges, etc. Without loss of generality, we will use the Cell-phones relation for examples throughout the instant application.

Promotional rules can be specified at different granularities and can use arbitrary functions to express different discounts. For example, the rule p₁ in Table 2 applies to all Motorola cell-phones, while the rule p₂ applies to a specific cell-phone model. Finally, the rule p₃ applies a fixed discount to the total price of buying Siemens phones only. We capture these semantics by associating a set of promotional rules with each item. For the example shown in Tables 1 and 2, the items with ItemIds 1, 3 and 5 each have exactly one rule associated with them, i.e., p₄, p₃ and p₁, respectively. The item with ItemId 4 has two rules associated with it, p₁ and p₂, and the item with ItemId 2 has no rules associated with it.

Given an item i and an associated set of rules RSeti, a function can be defined Applyᵢ: RSeti×N→R, which intuitively takes in a rule pεRSeti and a quantity qεN, and returns the unit price for item i for quantity q using only rule p. In our running example, if we denote the Motorola Razr cell-phone as MRC, Apply_{MRC}(p₁, 1)=MRC.price, Apply_{MRC}(p₁, 2)=MRC.price, Apply_{MRC}(p₁, 3)=2×MRC.price/3, and so on. Similarly, Apply_{MRC}(p₂, 1)=MRC.price, Apply_{MRC}(p₂, 2)=0.90×MRC.price, Apply_{MRC}(p₂, 3)=0.90×MRC.price, and so on. FIGS. 2 and 3 show the evolution of the discounted price of the Motorola Razr cell-phone in Table 1 for increasing quantities for rules p₁ and p₂.

Finally, given item i, RSetᵢ and Applyᵢ, we can define the discounted price function fᵢ: N→R as follows:

fᵢ(q)=min({i.price}∪∪_{RεRSct}_{_{i(Apply}}ᵢ(R,q))) (1)

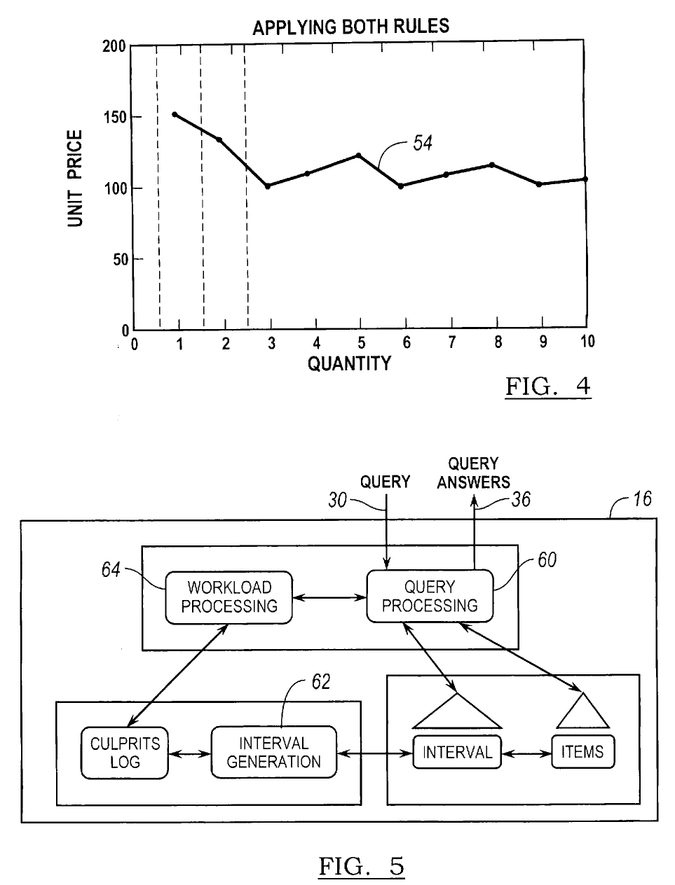

Intuitively, for a given quantity q, fᵢ(q) returns the minimum unit price for item i obtained by applying a discount rule unless there are no rules applicable to the item in which case the original price of the item is used. Note that there is an implicit assumption in the above definition that only one rule can be applied for an item at a given time. While this assumption is commonly made in many online stores, we can also define fᵢ to allow the application of a combination of rules. For the example of ItemId 4, line 50 in FIG. 2 corresponds to the rule “Buy at least 20, get 10% off” (p₂), while line 52 in FIG. 3 corresponds to the rule “Buy two, get the third free” (p₁). Line 54 in FIG. 4 shows how for ItemId 4, the two rules p₁ and p₂ are combined into a single function where the minimum discounted price is selected for each quantity (ignore the vertical bars for now). Note that for quantity 2, p₂ is applied since it computes the lowest price while for quantities 3 and above, p₁ is applied.

It will be assumed throughout the remainder of this application that an item I is associated with an arbitrary discounted price function fᵢ. The issue of whether fᵢ is obtained by applying one rule or a combination of rules is immaterial because the subsequent algorithms do not depend on this assumption.

The precompute interval (PI) approach will be considered throughout the remainder of this application. The key idea of this approach is to approximate a function fᵢ by a set of numbers. Specifically, the PI approach splits each fᵢ into one or more quantity intervals, and stores the minimum value of fᵢ for each interval. To see how this helps, consider the rule p₄ on Panasonic VS2 phones that was discussed in the previous section. If p₄ is split into two intervals, I₁ for quantities less than or equal to 2 and I₂ for quantities greater than 2, then the minimum prices of f₁ for I₁ and I₂ are good approximations of f₁; in fact, the minimum values for I₁ and I₂ exactly capture f₁ in this case and will not incur wasted work. Consequently, the PI approach may avoid wasted work by intelligently splitting fᵢ's into multiple intervals. In order to avoid an extremely large space requirement due to large number of intervals, a space budget (specified as the total number of intervals for all items) is provided as a parameter to the PI approach.

Table 3 shows a possible instantiation of the Intervals table. Each row in the table corresponds to a single interval for a given fᵢ. The first column stores the id of an item i, the second column lowq stores the low range of the interval, the third column highq stores the high range of the interval, the fourth column minfᵢ stores the minimum value of fᵢ for the interval and the final column stores fᵢ. For example, there are 3 intervals associated with ItemId 4; [1, 1], [2, 2], [3, ∞]; each of which is associated with the lowest discounted price value. This is illustrated by the vertical bars in FIG. 4. The rows in the table are stored in ascending order of minfᵢ.

TABLE 3

| ItemId | lowq | hHighq | minfᵢ | fᵢ |
|---|---|---|---|---|
| 3 | 2 | ∞ | $55 | p₃ |
| 3 | 1 | 1 | $80 | p₃ |
| 5 | 3 | ∞ | $80 | p₁ |
| 2 | 1 | ∞ | $90 | none |
| 4 | 3 | ∞ | $100 | P₁ |
| 1 | 3 | ∞ | $100 | P₄ |
| 5 | 1 | 2 | $120 | P₁ |
| 4 | 2 | 2 | $135 | P₂ |
| 4 | 1 | 1 | $150 | min(p_{1,} p₂) |
| 1 | 1 | 2 | $250 | P₄ |

In the query processing algorithm L is set to be the list of Interval ids that overlap with the query quantity Qty and that correspond to items that satisfy Pred. The computation of L can be optimized using traditional indices such as join indices (for finding the list of Interval ids that correspond to items that satisfy Pred) and interval/segment trees (for finding interval ids that overlap with the query quantity Qty).

Now referring to FIG. 5, an architecture is provided for generating and utilizing the intervals is provided. The query processing module 60 performs the thresholding algorithm based on the price of each item and returns the top-k list with their discounted price based on the promotional rules. The query processing module 60 invokes the index 70 into the items table 72 to return the item ids that match the query. Then the query processing module 60 uses the item ids and quantity to invoke index 68 to access interval table 66 and retrieve price intervals for each item id. The workload processing module 64 logs the culprits into the culprit log 74 for each query. The interval generation module 62 accesses the culprit log and the interval table to determine the appropriate quantity intervals per item given the space budget.

With regard to selecting intervals for the PI approach, one key challenge is to use the query workload to determine the best set of intervals that (a) reduce the overall query processing time, to (b) satisfy the space budget constraints. The naive solution to this problem—enumerating all possible sets of intervals—has computational complexity that is exponential in the number of items, which is clearly infeasible. However, some key properties relating fᵢ's and item intervals can be exploited to develop an algorithm that is both efficient and provably close to optimal.

ALGORITHM 1 Query Processing Algorithm

Require: k

| | |
|---|---|
| 1: | return top-k answer ranked by total discounted price |
| 2: | L := List of NewItems ids that satisfy Pred in id order (determined |
| | using indices) |
| 3: | Initialize ResultHeap of size k |
| 4: | for (id in L in increasing order of id) do |
| 5: | i = getRow(id) |
| 6: | if (i.minfᵢ ≧ price of kth item in ResultHeap) then |
| 7: | break; |
| 8: | else |
| 9: | iprice − i.fᵢ(Qty); |
| 10: | if (i.minfᵢ < price of k^{th} item in ResultHeap) then |
| 11: | ResultHeal.add(i, iprice); |
| 12: | end |
| 13: | end if |
| 14: | end |

The cost of evaluating a query Q using the PI algorithm (Algorithm 1), can be split into two components of the overall cost. The first component is the fixed cost, which is the cost of evaluating Q, independent of the choice of intervals. The fixed cost has three parts: (1) the index probes (line 1)¹, (2) k iterations of the for loop that add the top-k results to the result heap (lines 9-10)², and (3) the final iteration of the for loop when the termination condition is satisfied (lines 5-6). If we computed and stored all possible intervals, then each query would only incur the fixed cost.

The second component of the cost is the variable cost, which is the cost of evaluating a query after excluding the fixed cost. This component of the cost depends on the choice of intervals. Given a query Q and a specific choice of intervals P, if the Algorithm 1 iterates over its for loop m times, then the variable cost is the cost of evaluating m−k−1 iterations; these iterations correspond to items/intervals that are processed by the algorithm but which never make it to the top-k results. (We arrive at the number m−k−1 because out of the total of m iterations, k iterations are used to produce the actual top-k results, and the last iteration is for the termination condition,)

The total variable cost can be minimized over all queries in a query workload QW=[Q₁ . . . ,Qₙ]. In other words, all cost other than minimum fixed cost that must be incurred for each query Qᵢ can be minimized. Let I be the set of items, and let Ivals be the set of all possible quantity intervals.

Definition 1. Partition. A partition P is a function P:I→2^{Ivals} such that for all iεI, the intervals in P(i) (a) are non-overlapping (to avoid redundancy), and (b) cover the entire quantity range (to avoid missing quantities).

Intuitively, a partition is just a formal way to denote a specific choice of intervals.

Recall that the variable cost of evaluating a query Q using a partition P is defined as the cost of evaluating each one of the m−k−1 iterations (lines 9-10 in Algorithm 1). The cost of each iteration is considered to be a single unit and then define the variable cost of query Q can be defined using partition P, varcost(I,P,Q), to be m−k−1. In addition, the notation culprits(I,P,Q), can be defined which will be used extensively later, to refer to the set of items whose intervals are processed in the m−k−1 iterations of Q that contribute to its variable cost. Therefore, given a set of items 1, the set of all possible quantity intervals Ivals, a query workload QW, and a space budget s, a partition P can be found such that it minimizes the overall variable cost ΣQ_{εQW} (varcost(I,P,Q)) subject to the space constraint Σ_{iεI}|P(i)|≦s.

A simple way to identify the partition P is to explicitly enumerate all the partitions that satisfy the space budget, compute the cost for each such partition, and finally pick the partition that has the minimum cost. However, this algorithm is likely to be very inefficient due to the large number of possible partitions. Specifically, if the number of distinct query quantities is t, then the number of possible partitions is ‘2t×|I| s−|I|’. (There are 2t interval split points for each fᵢ, one before and one after every query quantity; thus, the total number of interval split points for all items is 2t×|I|. From these, s−|I| split points may be chosen, since we start with |I| intervals and each additional split increases the number of intervals by one.) Thus, for even modest sized databases, such as one having 10000 items, 10 query quantities and a space budget of 20000, we have ‘2×105 104’ possible partitions!

Fortunately, it turns out that a key property relating partitions can be exploited that dramatically reduces the set of partitions that need to be considered. We first introduce some notation before formally stating the independence property and presenting our algorithm.

Definition 2. Variable Cost of an Item. The variable cost for an item iεI given a partition P and a query workload QW is defined to be:

vcᵢ(I,P,QW)=|{Q|QεQW [symbol] iεculprits(I,P,Q)}|

(In this definition, { } refers to a bag, not a set, in order to deal correctly with duplicate queries.)

In other words, the variable cost for an item i may be defined by the number of times the item appears as a culprit in the query workload, i.e., the number of times an interval associated with an item is processed by the PI algorithm without the item being part of the final top-k result. It is easy to see that Σ_{iεI} vcᵢ(I,P,QW)=Σ_{QεQW} varcost(I,P,Q), i.e., the sum of the variable costs of all items is the same as the sum of the variable costs of all queries (which in turn is the same as the overall variable cost).

For notational convenience, maxprice(I,Q) is used to denote the maximum price of the top-k results obtained by evaluating Q over I (i.e., the price of the most expensive item in the top-k results). For ease of exposition, we assume that the values produced by evaluating fᵢ's for a given quantity are all unique, although this is not a limitation in practice (for instance, all non-unique fᵢ values can be made unique by appending the id of i).

Lemma 1. Independence Property. Given a set of items I and a space budget s, let AllParts be the set of all partitions that satisfy the space budget. Then, given a query workload QW:

∀iεI,∀P₁,P₂εAllParts,(P₁(i)=P₂ [symbol] vc₁(I,P₁,QW)=vc₁(I,P₂,QW))

Proof Sketch: Consider a partition PεAllParts and a query Q=(Preds,Qty, k)εQW. Let Qtylval_{Q,i} be the interval in P(i) that contains Qty. (Recall that the P(i)'s are non-overlapping and cover the entire quantity range, so there is exactly one interval that satisfies this condition.) From Algorithm 1, it can be seen that for an item i and query

$$Q \text{:} \begin{matrix}i ∈ culprits ( I , P , Q ) \\ ⇔ max price ( I , Q ) < {min}_{q ∈ {Qtylval}_{i}} {f}_{i} ( q )\end{matrix} i . e . ,$$

i is a culprit iff its minimum price in the interval that contains Qty is less than the top-k maximum price. Consequently, vcᵢ|{Q|QεQW [symbol] _{Q} [symbol] min_{qεQtyval}_{_{Q,i}}fᵢ(q)}|, which only depends on P(i) (in the definition of QtyIvalQ,i), and does not depend on P(j), j≠i. This proves the claim.

Informally, the property states that the benefit of choosing a particular set of intervals for item i is independent of the choice of intervals for other items. Consequently, the problem can be solved for each item separately, and then combined these to produce the overall solution. The overall complexity of the algorithm that exploits this observation is O(t³×|I|+s log|I|+|I|×|QW|), and it produces a solution that is within a factor (s−|I|−2t+1)/(s−|I|) of optimal (it is shown later that in fact, the complexity of the algorithm is usually much less, especially for the |I|×|QW| component).

The algorithm works in two steps. It first finds the optimal way to choose v intervals, 1≦v≦2t+1, for each item (recall that t is the number of query quantities seen, so there are 2t possible split points, one before and one after each query quantity, and thus a maximum of 2t+1 intervals). It then finds the global optimum by choosing v1, v2, . . . , v|I| such that v1+v2+ . . . +v|I|≦s and choosing vi intervals for item i gives us the globally optimal partition.

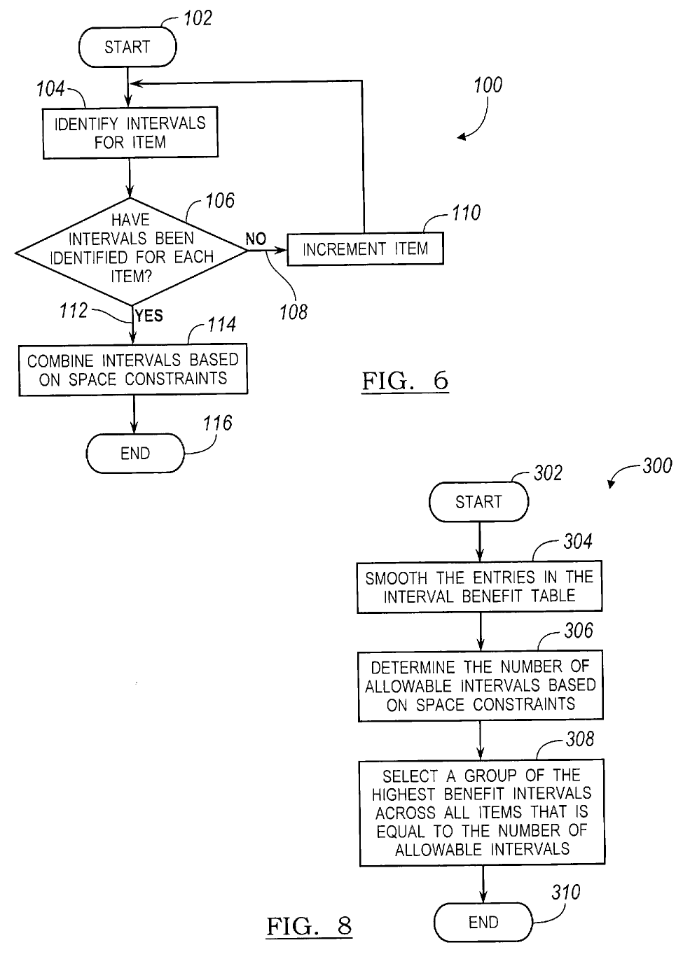

As shown in FIG. 6, a method 100 for generating a list of advertisements is provided. The method 100 may be executed in a precompute mode step prior to a query being received by the advertisement engine. For example, the method 100 may be executed upon entry of an item along with its associated advertisement information and pricing rules. The method 100 starts in block 102 and proceeds to block 104. In block 104, the advertisement engine identifies intervals for an item. In block 106, the advertisement engine determines if intervals have been identified for each item. If intervals have not been identified for each item the method follows wine 108 to block 110. In block 110, at item is increment in the method loops back to block 104. However, if intervals have been identified for each item the method follows wine 112 to block 114. In block 114 the intervals are combined based on space constraints. Accordingly, the number of intervals are selected for each item to produce the maximum benefit and/or the minimum variable cost. In block 116, the method 100 ends.

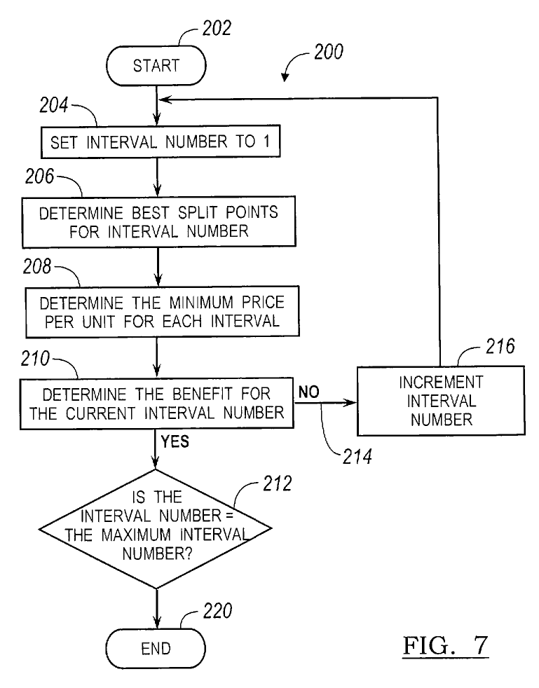

Now referring to FIG. 7, a method 200 for identifying intervals for each item is provided. The method starts in block 202 and proceeds to block 204. In block 24, the interval number is set to one. In block 206, the advertisement engine determines the best split points for the given interval number. The split points are determines such that he maximum benefit, for example the minimum number of culprits, is attained. In block 208, the advertisement engine determines the minimum price per unit for each interval. The advertisement engine also determines the benefit for the current interval number, as noted by block 210. To block 212, the advertisement engine determines if the interval number is equal to the maximum interval number. If the interval number is not equal to the maximum interval number, the method follows line to 214 to block 216. In block 216, the interval number is incremented in the method loops back to block 206.

Now referring to FIG. 8, a method 300 for combining intervals based on space constraints is provided. The method 300 begins in block 302 and proceeds to block 304. In block 304, the advertisement engine smoothes entries in the interval benefit table. Although, it should be noted that smoothing the benefit data and optional step that may or may not be employed. In block 306, the advertisement engine determines the number of allowable intervals based on the space constraints. Then a group of highest benefit intervals across all items are selected such that the group of selected intervals is equal to the number of allowable intervals. The method 300 then ends as noted by block 310.

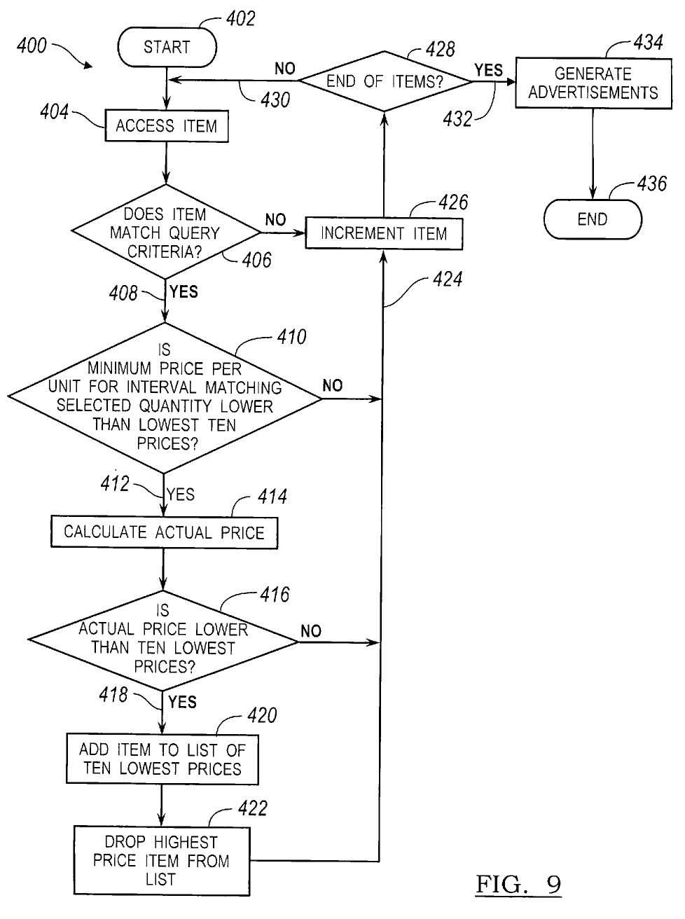

Now referring to FIG. 9, a method 400 is provided for generating a list of advertisements. The method 400 may be preformed in a query time processing mode. The method 400 starts in block 402 and proceeds to block 404. In block 404, the first item is accessed. In block 460 advertisement engine determines if the item matches the query criteria. If the item does not match the query criteria the method follows line 424 to block 426. If the item does match the query criteria the method 400 follows line 408 to block 410. In block 410, the advertisement engine determines if the minimum price per unit for the interval matching the selected quantity is a lower than the prices associated with the items on the list. If the minimum price per unit for the interval matching the selected quantity is not lower than the prices associated with the items on the list, the method 400 follows line 424 to block 426. If the minimum price per unit for the interval matching the selected quantity is lower than the prices associated with the items on the list, the method follows line 412 to block 414. In block 414, the advertisement engine calculates the actual price according to promotional rules for the quantity parameter provided by the query. In block 416, the advertisement engine determines if the actual price is lower than the prices associated with the items in the list. If the actual price is not lower than the prices associated with items in the list, the method 400 follows line 424 to block 426. If the actual price is lower than the prices associated with items in the list, the method 400 follows line 418 to block 420. In block 420, the advertisement engine adds the item to the list. Then the advertisement engine drops the highest priced item from the list, as to noted by block 422. The method one follows line 424 to block 426 where the item is incremented to the next item. In block 428, the advertisement engine determines if the current item is the last item to be analyzed. If the current item is not the last item to be analyzed the method follows line 430 to block 404 in the method 400 proceeds as described above. If the current item is the last item to be analyzed the method follows line 432 to block 434. In block 434, the advertisement engine generates the list of advertisements based on the item list, after which the method ends as denoted by block 436.

Now these steps will be described in more detail. The first step can be solved efficiently using dynamic programming and the second step can be solved using a variant of the knapsack problem.

The current problem is to find for each item i, the optimal way to choose 1 interval, 2 intervals, . . . , 2t+1 intervals. Here, optimal means minimizing the variable cost vcᵢ. In order to solve this problem, a Culprits table is created using the query workload. The Culprits table has three columns, ItemId, Quantity and MaxTop−kPrice, and it contains the following set of rows:

((ItemId,Quantity,MaxTop−kPrice)2Culprits|

QεQŴItemIdεculprits(I,P₀,Q)

̂Quantity=Q.Qty

̂MaxTop−kPrice=maxprice(I,Q)}

where P₀ is the partition in which each item is assigned the one interval that covers its entire quantity range. Intuitively, the Culprits table has one row for each culprit of each query, and the row contains the ItemId of the culprit, the quantity of the query, and the maximum price of the top-k results of the query. Table 4 shows an example Culprits table for different quantity values and queries.

TABLE 4

| ItemID | Quantity | MaxTop-kPrice |
|---|---|---|
| 4 | 5 | $110 |
| 4 | 5 | $109 |
| 4 | 5 | $105 |
| 4 | 5 | $108.5 |
| 4 | 5 | $109.75 |
| 4 | 4 | $108 |
| 4 | 4 | $106 |
| 4 | 7 | $102 |
| 4 | 7 | $105 |

Note that creating the Culprits table does not require additional processing; it can be easily created during regular query processing by initially running the PS approach using the P₀ partition, and logging the information for each culprit.

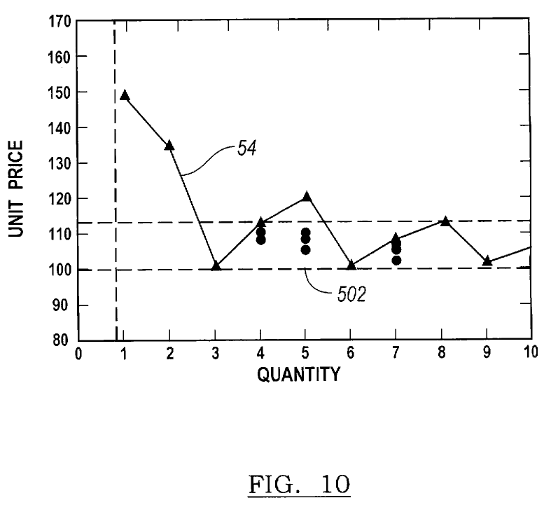

Given the Culprits table, we can determine the value of vcᵢ for a given choice of intervals for an item i. As an illustration of how this can be done, consider the item corresponding to ItemId 4 in Table 1, with f₄ and intervals shown in FIG. 4. This figure can be augmented by selecting the rows in the Culprits table that correspond to ItemId 4, and plotting each of these rows as a point on the figure where the x-coordinate of a row is its Quantity and the y-coordinate is MaxTop−kprice. Each of these points represents a potential culprit. FIG. 10 shows FIG. 4 augmented by plotting the points for ItemId 4 from the Culprits table (the scale on the x-axis has been altered slightly so that the points can be seen clearly). Now, suppose that item 4 is broken into intervals [1, 3], [4, 5], [6,1]. For each interval, a line can be drawn that represents the minimum value of f₄ in that interval. For example, for the interval [6,1], the minimum value line (MVL) 502 is drawn at a price of 100. In this case, exactly two points (i.e. potential culprits) fall between that line and the function graph in FIG. 10. For the interval [4, 5], the MVL is drawn at a price of 135, and we see all seven points (i.e. potential culprits) lie below this line. Finally, the MVL for [1, 3] occurs at price 100, and no points lie above it. In general, the total number of points that appear above these MVLs is exactly the value of vcᵢ. The intuition behind this reasoning is that if a particular set of intervals is chosen for an item i, then i can only be a culprit for a query Q if the minimum price of the relevant interval of i is less than the max top-k price of Q (otherwise, i would be pruned by the PI algorithm before it is processed). Consequently, only the points above the MVL for an interval contribute to vcᵢ.

Recall that the value of vcᵢ should be minimized for a given number of intervals v. Thus, in pictorial terms, v intervals should be chosen such that the number of points above the MVLs is minimized. Since it is convenient to think of this problem as a maximization problem, we can equivalently view the problem as maximizing the number of points below the MVLs. Thus, the benefit can be defined for each interval to simply be the number of points below its MVL, and then a set of intervals can be found such that the total benefit is maximized. More formally, for interval Ival of item i, its benefit can be defined as:

BENEFIT_{T}(Ival)=|{(ItemId,Quantity,MaxTop−kPrice)εCulprits|ItemId−i.id [symbol] MaxTop−kPrice<min_{qεIval}fᵢ(Quantity)}

and the best benefit for item I is broken into v intervals:

$${BESTBENEFIT}_{I} ( V ) = {max}_{p : \vert p ( i ) \vert = v} {\sum }_{Ival ℰ p ( i )} {BENEFIT}_{i} ( Ival ) .$$

Given the above definitions, a dynamic programming algorithm can be used to find the total benefit for the optimal set of intervals.

ALGORITHM 2 Interval Generation Algorithm

```
Require: Intervals {Ivalⱼₖ} for item i and
  1: {Ivalⱼₖ} for item i and
  2: Initialize B (Ivalⱼₖ) = BENEFITᵢ(Ivalⱼₖ) for j,k = 1, 2, ..., 2t +1.
  3: Initialize arrⱼ[1] = B(Ival₁ⱼ) for j = 1, 2, ..., 2t +1.
  4: for v = 2 to 2t + 1 do
  5:  for j = 1 to 2t + 1 do
  6:  arrⱼ[v] = max_{j′}>ⱼ{arr_{j′-1}[v − 1] +B(I_{j′j})}
  7:  end for
  8: end for
  9: BESTBENEFIT(v) = arr₁[l] for all l = 1, 2, ...2t + 1.
```

Algorithm 2 shows the pseudocode. The algorithm is similar to the dynamic programming algorithm for finding the VOPT histogram, which also finds optimal intervals of a query range but for a different context (query result size errors, as opposed to culprits in our case).

The algorithm is run on each item. The initialization phase first computes the benefit for every interval. Then, for each point between 1 and 2t+1, the algorithm computes the best number of intervals generated up to that point. The best number of intervals is computed in line 5 as the maximum benefit of a choice of intervals for that point. The naive implementation of the algorithm, run for all items, takes time Q(t3×|Table|), where |Table| is the size of the Culprits table; the t3 comes from the for-loops of the algorithm and |Table| comes from repeated calls to the Benefitᵢ(Ival) function, which can access all rows associated with an item for each call.

A key observation regarding the Culprits table is that its rows can be aggregated to record the number of culprits instead of each culprit individually. In this case, the cumulative benefit for each interval can be pre-computed in the initialization phase. This makes the running time of the algorithm essentially independent of the size of the Culprits table. The complexity is thus reduced to O(t3×|I|+|Table|), which is usually much smaller than Q(t3×|Table|).

In the previous subsection, how to break the interval of a given item into v pieces was described in such a way that the number of avoided culprits was maximized, for any given v. For the i-th item, we denoted this number by BestBenefitᵢ(v). Recalling that a storage constraint limits the use of most s items, we v₁+v₂+ . . . +v_{|I|}≦s is found such that BestBenefit₁(v₁)+ . . . +BestBenefit_{|I|}(v_{|I|}) is as large as possible.

Throughout, it is assumed that each item will be broken into at most 2t+1 pieces. For each i and j, the incremental improvement is tracked of using j+1 intervals to describe the i-th item, instead of just j. cᵢⱼ is used to denote that improvement.

cᵢⱼ=BestBenefitᵢ(j+1)−BestBenefitᵢ(j).

Notice that Σⱼ₌ᵢ^{k} cᵢⱼ=BestBenefitᵢ(k+1) since the sum telescopes. Thus rephrase our problem as finding k₁+ . . . +k_{|I|}≦sdiff such that Σᵢ₌₁^{|I|} Σⱼ₌₁^{ki} Cᵢⱼ is maximized. (For readability, sdiff=s−|I| is defined throughout this section.)

As a running example, Table 5 contains several items and their interval benefits. The item with ItemId 4, for example, contains the sequence 0, 7, 2, indicating that using two intervals gives no benefit over using one, while using three intervals gives a benefit of 7 over using two intervals, and using four intervals gives a benefit of 2 over using three intervals. (That is, c₄₁=0, c₄₂=7, C₄₃=2.) For simplicity in our example, we assume that there are only four items in I.

TABLE 5

| ItemID | Cᵢⱼ |
|---|---|
| 4 | 0, 7, 2, 4 |
| 6 | 5, 4, 1, 0 |
| 7 | 8, 4, 0, 0 |
| 8 | 4, 1, 1, 1 |

There is a dynamic programming algorithm to solve this problem exactly. Continuing the above example with sdiff=5, this algorithm would take 5, 4 from the item with ItemId=6; it would take the 8, 4 from item 7; and it would take the 4 from item 8. Thus, the total benefit is 25, and the algorithm indicates that item 4 should be described with just one interval, items 6 and 7 using three intervals, and item 8 using 2 intervals.

Although the dynamic programming algorithm works in polynomial time, the approach takes O(sdiff×|I|) time just to execute its outer loop. Since sdiff and |I| are both extremely large, this approach is impractical, even in our off-line setting.

However, we note that if cᵢⱼ≧cᵢⱼ for all i and all j<j′, the exact solution can be found very efficiently using the greedy algorithm: Simply find the sdiff largest cᵢⱼ, where if cᵢⱼ=c_{ij′} with j<j′, then the tie us broken in favor of cᵢⱼ. For each i, let kᵢ be the largest index such that the algorithm took cᵢkᵢ. Since cᵢⱼ≧c_{ij′} for all j≦j′, it is not hard to see that the algorithm must have taken cᵢ₁, cᵢ₂, . . . , cᵢkᵢ. Hence, k₁+ . . . +k_{N}=sdiff, and we have the optimal sum since we have the largest sdiff values. For example, if we ignore the item with ItemId=4 in Table 5, then we have cᵢⱼ≧cᵢⱼ for all i and all j<j′. Thus, if sdiff=5, we can simply pick the largest sdiff values, which correspond to 5, 4 for item 6, 8, 4 for item 7 and (the first) 3 for item Note that finding the top sdiff values from |I| lists can be done extremely efficiently. By maintaining a pointer into each list and having a heap-like structure, we can find the top sdiff values in O((sdiff+|I|)log|I|)=O(s log |I|) time.

Unfortunately, cᵢⱼs will not be decreasing in general. In fact, Table 5 produced from FIG. 10 reflects this. More concretely, consider the example with ItemId=4 in FIG. 10 ignoring the intervals shown. To split this item into two intervals, no choice of an interval split point would avoid any culprits (because queries are only for quantities 4, 5, and 7, and splitting on either side of these quantities offers no benefit because the MVLs of the resulting intervals will still be at 100). Thus, c₄₁=0 in this case. However, to split the item into three intervals, it can be split into the intervals shown in FIG. 10, and this would avoid 7 culprits. Thus, c₄₂=7<c₄₁.

So in general, it is not the case that cᵢⱼ≧c_{ij′} for all I and j<j′. However, it is still possible to efficiently find a provably good approximation to the optimal solution. The approach is to “smooth” the cᵢⱼ to produce c′ᵢⱼ such that c′ᵢⱼ 2c′_{ij′} for all i and j<j′, along with other properties. Using this technique, a solution may be found at least (sdiff−t)/sdiff times as good as optimal. Since we expect sdiff is expected to be thousands of times larger than t in practice, this shows that the approximate solution is better than 99.9% of optimal.

As an illustration of the smoothing technique, consider again the item with ItemId 4 in Table 5. Intuitively, the 7 is preferred. However, the 0 is used first. So the 0, 7 may be replaced with two copies of their average: 3.5, 3.5. Notice that taking 0, then 7, is helpful exactly when taking 3.5 followed by 3.5 is helpful. Continuing, the 2, 4 are replaced with two copies of their average: 3, 3. In general, the prefix sequence is found with the largest average; this may simply be the first item of the sequence. Then each of those values is replaced with the average, and recursively iterated on the remaining sequence. Since items 6, 7, and 8 already have cᵢⱼ that are decreasing, nothing is done for those items. The smoothed values are provided in Table 6.

TABLE 6

| ItemID | Cᵢⱼ |
|---|---|
| 4 | 3.5, 3.5, 3, 3 |
| 6 | 5, 4, 1, 0 |
| 7 | 8, 4, 0, 0 |
| 8 | 4, 1, 1, 1 |

With the smoothed values c′ ij in hand, we simply find the sdiff largest values, where if c′ᵢⱼ=c′_{i′j′}, then we break ties in favor of c′ᵢⱼ if i<i′; if i=i′ as well, we break ties in favor of c′ᵢⱼ when j<j′. As we noted above, this can be done in O(s log |I|) time.

To illustrate, consider the example, now with sdiff=8. the heap is initialized with the values 3.5, 5, 8, 3 (taking O(|I| log |I|) time), and a pointer is maintained to the first element in each item's list. The maximum value is extracted from the heap, 8, in O(lg |I|) time, and update the pointer for item 7 to point to the second element in its list. Then this value (in this case, 4) is added to the heap. Repeating this, the maximum value, now 5, is extracted and the pointer for item 6 is updated to point to the second item in its list. This value, 4, is added to the heap. On the third iteration, 4 is extracted and 1 (the third item in the list for item 6) is inserted. Then 4, 4, 3.5, 3.5, and 3 are extracted. Hence, the smoothed values that were extracted include 8, 5, 4, 4, 4, 3.5, 3.5, 3 corresponding to the original values 8, 5, 4, 4, 4, 0, 7, 2. Notice that the sum of the smoothed values 3.5+3.5 are exactly equal the original values 0+7. However, the last smoothed value that was extracted, 3, corresponds to 2. In general, at most the last 2t+1 values (which all come from the same item) will be overestimates of the original values. Thus, when translating the c′ᵢⱼ back to the original cᵢⱼ, the total benefit obtained using these smoothed value is at least (sdiff−2t+1)/sdiff of optimal.

For the sake of completeness, an outline of a smoothing algorithm is provided. For readability, the notation

$$Avg ( {c}_{ij} , … , {c}_{ik} ) = \frac{1}{k - j + 1} {\sum }_{l = j}^{k} {c}_{1}$$

Essentially, the algorithm starts at a cᵢⱼ and looks ahead to see if there is any subsequent cᵢⱼ′ that can increase the average value of all intermediate cᵢₖ, j≦k<j′. As can be seen, this algorithm has complexity O(t²).

The overall complexity of finding a nearly optimal partition is the sum of the complexity of processing the query workload, plus the complexity of generating intervals for individual items, plus the complexity of finding the optimal combination of intervals across items. As was already noted, processing the query workload takes at most O(|I|×|QW|) time, although this is actually the size of the log, which will usually be much smaller. The running time to find optimal partitions for each item takes a total of O(t3×|I|) over all items. (ignoring the cost of processing the Culprits table, since it is subsumed in the processing time of the query workload.) The running time for finding a nearly optimal combination of intervals across times is O(s log |I|), and smoothing takes O(t²×|I|). Hence, the total complexity is O(t3×|I|+s log |I|+|I|×|QW|).

Novel techniques are presented to evaluate top-k queries over data items whose score is dynamically computed using functions. The functions may be promotional rules which apply to different item quantities. The techniques applied rely on pre-computing appropriate quantity intervals per item and use them to prune items that do not make it to the top-k result. Experiments show that query evaluation using quantity intervals is scalable in the number of items and functions and performs several orders of magnitude better than the naive approach.

Although the above examples relate to shopping for a cell phone, the algorithm is also applicable to shopping for hotel rooms or entirely different applications such as searching traffic routes. As such, an on-line map may rank routes by predicting a congestion level, where the congestion score is a function of the time of day being queried. Accordingly, the quantity of items purchased, from the shopping example, corresponds to the time of day. As such, the congestion score is a query dependent scoring relationship. Destination and origin addresses may be used to find a list of the top-k least congested routes between two addresses. The congestion for a particular time of day may be estimated by rules such as “at 3:00 p.m., congestion level on Highway 280 in a ten mile radius around Palo Alto is high.” Further, the rules may even be inferred from past traffic data. Similar to the price of cell phones, the congestion level is not constant but is a function of the time of day and can be characterized by intervals.

In alternative embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

We claim:

1. A method for generating a list of advertisements for display to a user, the method comprising the steps of:
providing a list of items;
providing at least one quantity dependent pricing rule for each item;
identifying a number of intervals for each item that minimizes variable time cost;
combining the intervals for each item based on a space constraint.

2. The method according to claim 1, wherein identifying a number of intervals for each item includes indexing from one interval to a maximum number of intervals, determining a benefit score for adding each additional interval and storing each benefit score.

3. The method according to claim 1, wherein combining the intervals for each item based on a space constraint includes smoothing a plurality of benefit scores for each interval.

4. The method according to claim 1, wherein combining the intervals for each item based on a space constraint includes determining a number of allowable intervals based on the space constraint and selecting a group of highest benefit intervals across all items that is equal to the number of allowable intervals.

5. The method according to claim 1, wherein the steps of
providing the list of items;
providing the at least one pricing rule for each item;
identifying the number of intervals for each item that minimizes variable time cost; and
combining the intervals for each item based on the space constraint;
are performed in a preprocessing step.

6. The method according to claim 1, further comprising the steps of
receiving a query including a quantity parameter
indexing through each item of a plurality of items
determining if the minimum price for an interval corresponding to the quantity term is less than a price associated with a list item in a top-k list;
adding the item to the top-k list;
removing the list item with a highest associated price

7. The method according to claim 1, further comprising the steps of
adding the item to a top-k list after a determination that a minimum price per unit for the interval associated with the quantity parameter is less than the price associated with a list item in the top-k list;
removing the list item with the highest price.

8. The method according to claim 1, further comprising the steps of
calculating an actual price for the item
adding the item to a top-k list after a determination that the actual price per unit for the interval associated with the quantity parameter is less than the price associated with a list item in the top-k list;
removing the list item with the highest price.

9. A system for generating advertisements for display to a user, the system comprising:
a query engine configured to receive a query from the user, the query engine being configured to identify a quantity parameter; and
an advertisement selection engine in communication with the query engine and configured to receive the query including the quantity parameter, the advertisement selection engine having a precompute module and a query time module;
the precompute module being configured to calculate intervals for each item of a plurality of items to minimize variable cost for each item and combine the intervals each item based on a space constraint;
the query time module being configured to index through each item of the plurality of items and add each item to a list after a determination is made that a price associated with each item is lower than the price associated with each item in the list.

10. The system according to claim 9, wherein the advertisement engine is configured to index from one interval to a maximum number of intervals, calculate a benefit score for adding each additional interval, and store each benefit score.

11. The system according to claim 9, wherein the advertisement engine is configured to smooth a plurality of benefit scores for each interval.

12. The system according to claim 9, wherein the advertisement engine is configured to calculate a number of allowable intervals based on the space constraint and select a group of highest benefit intervals across all items that is equal to the number of allowable intervals.

13. In a computer readable storage medium having stored therein instructions executable by a programmed processor for updating bids for an advertisement, the storage medium comprising instructions for:
providing a list of items;
providing at least one pricing rule for each item;
identifying a number of intervals for each item that minimizes variable time cost;
combining the intervals for each item based on a space constraint.

14. The computer readable storage medium according to claim 13, wherein identifying a number of intervals for each item includes indexing from one interval to a maximum number of intervals, determining a benefit score for adding each additional interval and storing each benefit score.

15. The computer readable storage medium according to claim 13, wherein combining the intervals for each item based on a space constraint includes smoothing a plurality of benefit scores for each interval.

16. The computer readable storage medium according to claim 13, wherein combining the intervals for each item based on a space constraint includes determining a number of allowable intervals based on the space constraint and selecting a group of highest benefit intervals across all items that is equal to the number of allowable intervals.

17. The computer readable storage medium according to claim 13, wherein the steps of
providing the list of items;
providing the at least one pricing rule for each item;
identifying the number of intervals for each item that minimizes variable time cost; and
combining the intervals for each item based on the space constraint;
are performed in a preprocessing step

18. The computer readable storage medium according to claim 13, further comprising the steps of
receiving a query including a quantity parameter
indexing through each item of a plurality of items
determining if the minimum price for an interval corresponding to the quantity term is less than a price associated with a list item in a top-k list;
adding the item to the top-k list;
removing the list item with a highest associated price

19. The computer readable storage medium according to claim 13, further comprising the steps of
adding the item to a top-k list after a determination that a minimum price per unit for the interval associated with the quantity parameter is less than the price associated with a list item in the top-k list;
removing the list item with the highest price.

20. The computer readable storage medium according to claim 13, further comprising the steps of
calculating an actual price for the item
adding the item to a top-k list after a determination that the actual price per unit for the interval associated with the quantity parameter is less than the price associated with a list item in the top-k list;
removing the list item with the highest price.

21. A method for generating an ordered list for display to a user, the method comprising the steps of:
providing a list of items;
providing at least one query dependent scoring relationship for each item;
identifying a number of intervals for each item that minimizes variable time cost;
combining the intervals for each item based on a space constraint.

22. The method according to claim 21, wherein identifying a number of intervals for each item includes indexing from one interval to a maximum number of intervals, determining a benefit score for adding each additional interval and storing each benefit score.

23. The method according to claim 21, wherein combining the intervals for each item based on a space constraint includes smoothing a plurality of benefit scores for each interval.

24. The method according to claim 21, wherein combining the intervals for each item based on a space constraint includes determining a number of allowable intervals based on the space constraint and selecting a group of highest benefit intervals across all items that is equal to the number of allowable intervals.
